(19) United States
(12) Patent Application Publication
(10) Pub. No.: US 2018/0080585 A1
(43) Pub. Date: Mar. 22, 2018

(54) FLUOROELASTOMER/EPDM HOSE FOR COLD-SIDE CHARGE AIR APPLICATIONS

(71) Applicant: ContiTech MGW GmbH, Hannoversch Munden (DE)

(72) Inventors: Sebastian Seibold, Hannoversch Munden (DE); Thomas George Burrowes, North Canton, OH (US); David J. Maguire, Hudson, OH (US); Henry Yang, Copley, OH (US)

(73) Assignee: ContiTech MGW GmbH, Hannoversch Munden (DE)

(21) Appl. No.: 15/268,691

(22) Filed: Sep. 19, 2016

(51) Int. Cl. F16L 11/08; F16L 11/02

(52) U.S. Cl. CPC F16L 11/085; F16L 11/02

(57) ABSTRACT

A hose includes an inner layer containing a fluoroelastomer, an outer layer containing one or more EPDM elastomer and EPM elastomer, and at least one textile reinforcement layer disposed between the inner layer and the outer layer. In some aspects, the at least one textile reinforcement layer is wound directly onto inner layer. Further, the textile reinforcement layer(s) may be an open braid textile which facilitates direct contact between the outer layer and the inner layer. In some cases, the fluoroelastomer has a fluorine content which is within the range of 64 weight percent to 71 weight percent. The fluoroelastomer may have repeat units which include at least two perflurorinated monomers and at least one cure site monomer, while in other cases, the fluoroelastomer has repeat units which include a perfluoroolefin monomer, a perfluorovinyl ether monomer, and a cure site monomer.

### FIELD

The field to which the disclosure generally relates to is a flexible hose, and in particular a flexible hose for use as a charge-air hose.

### BACKGROUND

This section provides background information to facilitate a better understanding of the various aspects of the disclosure. It should be understood that the statements in this section of this document are to be read in this light, and not as admissions of prior art.

The connection between turbocharger and charge-air cooler (hot side), and the connection between charge-air cooler and the engine air intake manifold (cold side) are mostly achieved by using what are known as charge-air hoses. Both the hot side and the cold side here must withstand relatively high pressures, and must also be sufficiently flexible to compensate the relative motion between engine and charge-air cooler. Comparable requirements are also placed upon other hoses, for example industrial hoses, which likewise have to withstand high pressures and varying temperatures.

The higher engine powers of modern turbo-powered vehicles demand increasingly stronger charge air pressures. This also involves higher charge air temperatures which put extreme stresses on the charge air hoses on the hot side. The charge air temperatures are about 200° C. with an overpressure of up to 3.5 bar, relative. Four-layer charge air hoses are known for these temperature ranges, which typically include an inner layer of FKM fluoroelastomer, an intermediate layer and outer layer of silicone and a reinforcing layer, e.g. of an aramid fibre. FKM (by ASTM D1418 standard) is the designation for about 80% of fluoroelastomers as defined in ASTM D1418, and FKM contains vinylidene fluoride as a monomer. The use of silicone in the state of the art is typical for applications in the high temperature range, because conventional rubber mixtures cannot withstand these temperatures and pressures. In some other applications, ethylene acrylic rubber (AEM) or alkyl acrylate copolymer (ACM) are used instead of silicone. In yet other cases, an alternative barrier layer is based upon FVMQ fluorosilicones elastomer instead of FKM.

Standard cold side hoses for charge air applications have the main requirements of a service temperature between 100° C. and 150° C., and media resistance against engine fluids such as oils, fuels like diesel, benzene, and the like. The main polymers used in outer layers for these types of hoses are chloroprene, chlorinated polyethylene, and in certain cases, AEM.

Vehicles with exhaust gas recirculation are currently increasing with the next generations of engines, and hot side/cold side charge-air hoses are key components in these engines. Hoses using elastomer compounds based on chlorinated polymers (like CR and CM) in inner layers will not likely meet the requirements as the polymers are not acid stable and during the compounding basic fillers such as calcium oxide and calcium hydroxide are added to scavenge hydrochloric acid released by the polymers. These basic fillers will further decrease acid resistance properties of these compounds. While AEM is better in acid resistance, use of such may be borderline depending on application and specification, since AEM may hydrolyze under certain acidic conditions.

Thus, there is a need for cold side charge-air hoses with sufficient flexibility, engine media resistance, and acid/base resistance, such need met at least in part, with the following disclosure.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some embodiments of the disclosure, hoses include an inner layer containing a fluoroelastomer, an outer layer containing one or more EPDM elastomer and/or EPM elastomer, at least one textile reinforcement layer disposed between the inner layer and the outer layer, and an optional adhesion promoting layer. In some embodiments, an intermediate layer is disposed at a suitable position between the inner layer and the outer layer, where the intermediate layer contains fluoroelastomer, EPM elastomer, EPDM elastomer, or any combination thereof.

In some aspects, the at least one textile reinforcement layer is wound directly onto inner layer. In some embodiments, the optional adhesion promoting layer is disposed between two or more of the inner layer, the outer layer and the at least one textile reinforcement layer. The textile reinforcement layer(s) may be tubular knit or a tubular braid which has been knitted, braided, or spiralized. In some aspects, the textile reinforcement layer(s) may be an open braid textile which facilitates contact between the outer layer and the inner layer.

In some cases, the fluoroelastomer has a fluorine content which is within the range of 64 weight percent to 71 weight percent. The fluoroelastomer may have repeat units which are comprised of at least two perflurorinated monomers and at least one cure site monomer, while in other cases, the fluoroelastomer has repeat units which are comprised of a perfluoroolefin monomer, a perfluorovinyl ether monomer, and a cure site monomer.

Where the fluoroelastomer has repeat units which are comprised of a perfluoroolefin monomer, a perfluorovinyl ether monomer, and a cure site monomer, the perfluoroolefin monomer may be selected from the group consisting of vinylidene fluoride, hexafluoropropylene, and tetrafluoroethylene. In some embodiments, the perfluoroolefin monomer is present in the fluoroelastomer at a level which is within the range of 20 weight percent to 80 weight percent, wherein the perfluorovinyl ether monomer is present in the fluoroelastomer at a level which is within the range of 20 weight percent to 80 weight percent, and wherein the cure site monomer is present in the fluoroelastomer at a level which is within the range of 0.1 weight percent to 5 weight percent.

In another aspect of the disclosure, embodiments are charge-air hoses which include an inner layer containing a fluoroelastomer, an outer layer containing a EPDM elastomer, a textile reinforcement layer, and an adhesion promoting layer containing an organophosphonium salt or organoammonium salt. The at least one textile reinforcement layer is disposed between the inner layer and the outer layer. The adhesion promoting layer is disposed between two or more of the inner layer, the outer layer and the textile reinforcement layer.

In yet another aspect of the disclosure, embodiments are hoses including an inner layer containing a fluoroelastomer, an outer layer containing a EPDM elastomer, a EPM elastomer, or combination thereof, and at least one textile reinforcement layer. The at least one textile reinforcement layer is disposed between the inner layer and the outer layer, and the outer layer is devoid of any silicone compound forming the outer layer.

### BRIEF DESCRIPTION OF THE DRAWINGS

Certain embodiments of the disclosure will hereafter be described with reference to the accompanying drawing, wherein like reference numerals denote like elements. It should be understood, however, that the accompanying FIGURE illustrates one implementation described herein and is not meant to limit the scope of various technologies described herein.

FIG. 1 illustrates in a perspective view, a three dimensional view of a charge-air hose, according to one aspect of the disclosure.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. While the materials used in the present disclosure are described herein as comprising certain components, it should be understood that the materials could optionally comprise two or more chemically different materials. In addition, the materials can also comprise some components other than the ones already cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value, dimension, concentration and/or amount range listed or described as being useful, suitable, or the like, is intended that any and every point within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Some embodiments according to the disclosure utilize a fluoroelastomer in the inner layer of a charge-air hose, and EPM elastomer or an EPDM elastomer in an outer layer. In some aspects, at least one textile reinforcement layer formed of a tubular knit or a tubular braid which has been knitted, braided, or spiralized, is disposed between the inner layer and the outer layer of a charge-air hose. In some embodiments, an intermediate layer including a combination of fluoroelastomer and EPM elastomer or EPDM elastomer is disposed at a suitable position between the inner layer and the outer layer.

The inner layer may include any suitable amount of fluoroelastomer, and in some embodiments, the inner layer includes up to about 90% by weight of total elastomer in the inner layer, or even up to about 100% by weight of total elastomer in the inner layer. Likewise, the outer layer may include any suitable amount of EPM elastomer or EPDM elastomer, and in some embodiments, the outer layer includes up to about 90%, or even up to about 100% by weight of EPM elastomer or EPDM elastomer, based up total elastomer in the outer layer. As used herein, the phrase “total elastomer” means total elastomer weight content which does not include the weight of other non-elastomer components, such fillers, curative, accelerators, activators and other common additives used in forming such layer.

In those embodiments where an intermediate layer is disposed between the inner layer and the outer layer, the elastomer in the intermediate layer may be a fluoroelastomer, an EPM elastomer, an EPDM elastomer, or any suitable combination thereof. The particular elastomer used may constitute up to about 100% by weight of the total elastomer in the outer layer. Where a combination of elastomer is used, weight range of each polymer could be from about 1% to about 99% by weight of either elastomer, from about 33% to about 66% by weight, or even about a 50:50 blend by weight of either elastomer.

The EPM elastomer or EPDM elastomer used in the outer layer may be any suitable EPM elastomer (ethylene-propylene monomer elastomer) or EPDM elastomer (ethylene-propylene-diene monomer elastomer). Some suitable examples of EPDM elastomers include, but are not limited to, ethylenepropylene-diene copolymer rubbers such as ethylene-propylene-cyclopentadiene terpolymer, ethylene-propylene ethylidene norbornene terpolymer, and ethylene-propylene-I, 4-hexadiene terpolymer.

The fluoroelastomer will typically have a fluorine content which is within the range of 64 weight percent to 71 weight percent and will frequently have a fluorine content which is within the range of 66 weight percent to 70 weight percent. The fluoroelastomer used in the inner layer of hoses are typically elastomeric fluoropolymers which are substantially fully fluorinated fluoropolymers which, when cured, exhibit an elastomeric character. The fluoroelastomers will typically contain nitrile groups or iodine or bromine atoms which render them crosslinkable.

Fluoroelastomers utilized in accordance with some aspects of this disclosure are polymers having copolymerized units of at least two principal fluorinated monomers. In some aspects, one comonomer is a perfluoroolefin, while the other is a perfluorovinyl ether. Representative perfluorinated olefins include tetrafluoroethylene and hexafluoropropylene. Suitable perfluorinated vinyl ethers are those of the formula:

CF₂═CFO(R_{f}O)ₙ(R_{f*}O)ₘR_{f}

wherein R_{f} and R_{f*}, are different linear or branched perfluoroalkylene groups of 2-6 carbon atoms, wherein m and n are independently integers from 0 to 10, and wherein R_{f} is a perfluoroalkyl group containing from 1 to 6 carbon atoms.

A useful class of perfluoro(alkyl vinyl) ethers includes compositions of the formula:

CF₂═CFO(CF₂CFXO)ₙR_{f}

wherein X is F or CF₃, wherein n is an integer from 0 to 5, and wherein R_{f} is a perfluoroalkyl group containing from 1 to 6 carbon atoms. In some cases, the perfluoro(alkyl vinyl) ethers includes those ethers wherein n is represents 0 or 1 and wherein R_{f} contains from 1 to 3 carbon atoms. Examples of such perfluorinated ethers include perfluoro(methyl vinyl) ether and perfluoro(propyl vinyl) ether. Other useful monomers include compounds of the formula:

CF₂═CFO[(CF₂)ₘCF₂CFZO]ₙR_{f}

wherein R_{f} is a perfluoroalkyl group containing from 1 to 6 carbon atoms, wherein m represents 0 or 1, n represents an integer from 0 to 5, and wherein Z represents a fluorine atom or CF₃. Preferred members of this class are those in which R_{f} represents s a —C₃F₇ group, wherein m represents 0, and wherein n represents 1.

Additional perfluoro(alkyl vinyl) ether monomers include compounds of the formula:

CF₂═CFO[(CF₂CFCF₃O)ₙ(CF₂CF₂CF₂O)ₘ(CF₂)ₚ]CₓF₂ₓ₊₁

wherein m and n represent integers from 1 to 10, wherein p represents an integer from 0 to 3, and wherein x represents an integer from 1 to 5. Preferred members of this class include compounds where n represents 0 or 1, wherein m represents 0 or 1, and wherein x represents 1.

Examples of useful perfluoro(alkoxy vinyl) ethers include those of the structural formula:

CF₂═CFOCF₂CF(CF₃)O(CF₂O)ₘCₙF₂ₙ₊₁

wherein n represents an integer from 1 to 5, wherein m represents an integer from 1 to 3, and wherein n is preferably 1. Mixtures of perfluoro(alkyl vinyl) ethers and perfluoro(alkoxy vinyl) ethers may also be used.

Some useful perfluoroelastomers are composed of tetrafluoroethylene and at least one perfluoro(alkyl vinyl) ether as principal monomer units. In such copolymers, the copolymerized perfluorinated ether units constitute from about 15-50 mole percent of total monomer units in the polymer.

In some aspects, the perfluoropolymer further contains repeat units which are comprised of at least one cure site monomer to make the fluoroelastomer curable with peroxide curing agents. In some aspects, it may be important to attain good adhesion between the layer of fluoroelastomer in the hose and adjacent layer of EPDM or EPM elastomer. For instance, this may be important in cases where the hose is comprised of an inner layer of the fluoroelastomer and an outer layer of an EPDM or EPM elastomer. This is also true in cases where the fluoroelastomer inner layer is adhered directly with the outer layer, or another intermediate layer within the hose. In such systems the fluoroelastomer is co-cured with the EPDM or EPM elastomer utilizing a peroxide curative system. For this reason, it is desirable for the fluoroelastomer to be peroxide curable rather than curable with a bisphenol curative system.

The peroxide curing agents which can be used in the practice of the present invention are those which are generally suitable for curing EPDM or EPM elastomer. Some representative examples of organic peroxides which can be used include, but not limited to, dicumyl peroxide, bis-(t-butyl peroxy-diisopropyl benzene, t-butyl perbenzoate, di-t-butyl peroxide, 2,5-dimethyl-2,5-di-t-butylperoxyhexane, alpha-alpha-bis(t-butylperoxy) diisopropylbenzene, methylethyl ketone peroxide, cyclohexanone peroxide, cumene hydroperoxide, pinane hydroperoxide, p-menthane hydroperoxide, t-butyl hydroperoxide, di-t-butyl peroxide, and the like. Dicumyl peroxide and di-t-butyl peroxide are highly preferred peroxide compounds. In any case, the peroxide crosslinking agent will typically be supported on an inert powdered carrier, such as silica, clay or calcium carbonate. The peroxide will typically be present on the powdered carrier at a level which is within the range of about 40 weight percent to about 70 weight percent and more typically at a level with is within the range of about 50 weight percent to 60 weight percent, based upon the total weight of the peroxide and the carrier.

In some aspects, the fluoroelastomer further contains copolymerized units of at least one cure site monomer, generally in amounts of from 0.1 weight percent to 5 weight percent to make the fluoroelastomer peroxide curable so that it can be co-cured with EPDM and/or EPM elastomer. The cure site monomer will preferably be included at a level with is within the range of 0.3 weight percent to 1.5 weight percent. Although more than one type of cure site monomer may be present, most commonly one cure site monomer is used and it contains at least one nitrile substituent group. Suitable cure site monomers include nitrile-containing fluorinated olefins and nitrile-containing fluorinated vinyl ethers. Some useful nitrile-containing cure site monomers include those of the following structural formulas:

CF₂═CF—O(CF₂)ₙ—CN,

wherein n represents an integer from 2 to 12 and which is preferably an integer from 2 to 6;

CF₂═CF—O[CF₂—CFCF₂—O]ₙ—CF₂—CFCF₃—CN

wherein n represents an integer from 0 to 4 and which is preferably an integer from 0 to 2;

CF₂═CF—[OCF₂CF₂(CF₃)]_{c}—O—(CF₂)ₙ—CN

wherein x represents an integer from 1 to 2 and wherein n represents an integer from 1 to 4; and

CF₂═CF—O—(CF₂)ₙ—O—CF(CF₃)—CN

wherein n represents an integer from 2 to 4.

Especially preferred cure site monomers are perfluorinated polyethers having a nitrile group and a trifluorovinyl ether group. A most preferred cure site monomer is perfluoro(8-cyano-5-methyl-3,6-dioxa-1-octene) or 8-CNVE. A detailed description of such fluoroelastomers and cure site monomers which can be utilized in the synthesis curable fluoroelastomers is provided in U.S. Pat. No. 6,191,208. The teachings of U.S. Pat. No. 6,191,208 are incorporated herein for the purpose of disclosing fluoroelastomers which can be utilized in the practice of this invention. Other cure site monomers such as those described in U.S. Pat. No. 4,281,092 and U.S. Pat. No. 5,789,509 can also be utilized in the fluoroelastomers employed in the conveyor belts of this invention. The teachings of U.S. Pat. No. 4,281,092 and U.S. Pat. No. 5,789,509 are incorporated herein by reference for the purpose of describing such cure site monomers.

Brominated α-ofefins and iodinated α-olifins olefin in which at least one hydrogen atom has been replaced with a bromine atom or an iodine atom, respectively, and optionally, one or more of the remaining hydrogen atoms have been replaced with an atom of another halogen, preferably fluorine can be also be utilized as the cure site monomer in making peroxide curable fluoroelastomers which can be utilized in accordance with this disclosure. Some compounds of this type are available commercially and others can be prepared by methods known in the art, for example, as shown by Tarrant and Tandon, J. Org. Chem. 34, 864 (1969) and by Fainberg and Miller, 79 JACS 4170 (1957) and J. Org. Chem. 42 1985-90 (1977).

Some representative bromine-containing olefins which are copolymerizable with the monomers used to form the fluoroelastomers of this invention include bromotrifluoroethylene, 1-bromo-2,2-difluoroethylene, 4-bromo-3,3,4,4-tetrafluorobutene-1, vinyl bromide, 1-bromo-1,2,2-trifluoroethylene, perfluoroallyl bromide, 4-bromo-1,1,2-trifluorobutene, 4-bromo-1,1,3,3,4,4-hexafluorobutene, 4-bromo-3-chloro-1,1,3,4,4-pentafluorobutene, 6-bromo-5,5,6,6-tetrafluoro-hexene, 4-bromo-perfluorobutene-1, and 3,3-difluoroallylbromide. It is preferable to use sufficient units of the brominated olefin to provide at least 0.05 weight percent bromine, usually about 0.3-1.5 weight percent bromine, in the fluoroelastomer. The fluoroelastomers contain up to 3 mole percent, based on the total moles of the fluoroelastomer, of units derived from the bromine-containing olefin, usually at least about 0.2 mole percent. Bromine-containing olefins used according to the disclosure, are further described in U.S. Pat. No. 4,214,060, which is incorporated herein in its entirety, by reference. Representative iodine-containing olefins in amounts up to 3 mole percent which are copolymerizable with the monomers used to form the fluoroelastomers of this invention include compounds of the formula CH₂═CH(CF₂)ₓI where x is 2-6, more specifically, iodoethylene, 3-chloro-4-iodo-3,4,4-trifluorobutene, 2-iodo-1,1,2,2-tetrafluoro-1-(vinyloxy)ethane, 2-iodo-1-(perfluorovinyloxy)-1,1,-2,2-tetrafluoroethylene, 1,1,2,3,3,3-hexafluoro-2-iodo-1-(perfluorovinyloxy)propane, 2-iodoethyl vinyl ether, 3,3,4,5,5,5-hexafluoro-4-iodopentene, iodotrifluoroethylene, and preferably 4-iodo-3,3,4,4-tetrafluorobutene-1. Such brominated α-ofefins and iodinated α-olifins which can be utilized as the cure site monomer in making peroxide curable fluoroelastomers which can be utilized in accordance with the disclosure, are described in greater detail in U.S. Pat. No. 4,694,045, which is incorporated by reference herein for the purpose of describing such fluoroelastomers.

Fluoroelastomers useful in some embodiments according to the disclosure, in cured form, have physical properties, such as Shore A hardness values of up to 80, or even from about 60 to about 80; tensile strength of up to 30 MPa, or even from about 20 MPa to about 25 MPa; and/or elongation at break of up to about 600%, or even from about 400% to about 550%. In some aspects, after exposure to acetic acid solution with a pH value of 2.8 for 504 hrs at 100 deg C., useful cured fluoroelastomers have physical properties, such as Shore A hardness values of up to 80, or even from about 60 to about 80; tensile strength of up to 30 MPa, or even from about 15 MPa to about 25 MPa; elongation at break of up to about 600%, or even from about 400% to about 550%; weight increase of up to about 20%, or even from about 10% to about 15%; and/or volume increase of up to about 30%, or even from about 15% to about 25%.

In some embodiments, the textile reinforcement layer is made of a peripherally continuous, tubular knit or braid. In some aspects, a knit in the form of textile reinforcement is one produced from one or more yarns or yarn systems by looping of the yarn. The yarns here run in a transverse direction. The knit has sufficient strength while retaining flexibility. Although a textile insert made of woven material would be pressure-resistant, because of the relatively high thread count, it would be too stiff. Notwithstanding the particular construction or structure of the textile reinforcement layer, the textile used may be of any suitable material such as a polyester, polyamide, polyaramid, polyoxadiazole, polyetheretherketone (PEEK), polyphenylene sulfide (PPS), and the like.

The tubular textile reinforcement layer can also have been configured as an open braid which facilitates direct contact between the outer layer and the inner layer.

The wound textile insert is advantageously a flat knit. Because of the specific way in which the threads run within the flat knit, it is relatively flexible in all directions and has good draping qualities. It is further advantageous that the wound textile layer is a flat knit. It is further advantageous that the wound textile layer is a flexible flat woven material. This is stretchable in one direction. Transverse and longitudinal threads can move with respect to one another at their crossover points.

In some embodiments aramid fibres can be used in the textile reinforcing layer. In this respect the aramid fibres used give the hose an adequate strength with the simultaneous retention of the hose movement capability. Furthermore, aramid fibres have proven particularly suitable for suppressing pressure waves.

According to one embodiment the textile reinforcing layer can contain Kevlar®. This material has proven particularly suitable in practice. Kevlar® is a product from Dupont consisting of poly(p-phenylenterephthalamid) which features good temperature resistance, good tensile strength and a good modulus of elasticity at a low density.

According to another embodiment the textile reinforcing layer can contain Nomex®. Good hose properties can also be obtained using Nomex®. Nomex® is also manufactured by Dupont and consists of poly(m-phenylenisophthalamid). This material is particularly suitable due to good thermal and flame-resistant properties.

In some cases. the reinforcing layer can contain a combination of Kevlar® and Nomex®. In this way it is possible to combine the advantages of both materials without an additional layer being necessary.

In some aspects, fillers are used in the compositions forming the inner layer and/or outer layer, to enhance properties, to save money, to facilitate processing, to improve physical properties or for other reasons. A variety of filler materials are known. Such fillers include silica, carbon black, clay, organic fiber, inorganic metal powder, mineral powder, talc, calcium sulfate, calcium silicate, and the like. Typical levels of these and other fillers include from about 10 phr to 100 phr or higher. In various embodiments, the compositions contain 10-80, 30-70, 40-60, 50-60, or 35-60 phr filler. The compositions forming the inner layer and/or outer layer, may also contain other ingredients. These additives are well-known in the art and include distillates, curatives, adhesion promoters, accelerators, activators, processing aids, antioxidant packages, pigments, and the like.

In some embodiments, an adhesion promoter layer is provided between other layers to enhance bonding between the layers. For example, an adhesion promoter layer may be applied to an interfacial surface(s) of one or more of the inner fluoroelastomer layer, the outer layer comprising a EPDM elastomer, and the at least one textile reinforcement layer. Use of any suitable adhesion promoting material is within the scope of this disclosure. Some nonlimiting examples include adhesion promoting materials such as organophosphonium salts or organoammonium salts.

In some embodiments, an organophosphonium salt is used and may be selected from the group consisting of quaternary phosphonium salts containing alkyl substituted groups having 1 to 20 carbon atoms. In one embodiment the organophosphonium salts include organophosphonium halides such as tetrabutylphosphonium chloride, allyltributylphosphonium chloride, tetrabutylphosphonium bromide, tributyl(methoxypropyl)phosphonium chloride, benzyltriphenylphosphonium chloride, and benzyltrioctylphosphonium chloride. In another embodiment, the organophosphonium salt may be selected from quaternary phosphonium salts having a benzotriazolate anion, including, for example, organophosphonium benzotriazolates, such as tetrabutylphosphonium benzotriazolates and trioctylethylphosphonium benzotriazolates. In one embodiment, the organophosphonium salt is tetra-n-butyl phosphonium benzotriazolate, available as ZEONET PB from Zeon Chemicals. In some other embodiments, an organoammonium salt is used, and may be any suitable organoammonium compound, such as a quaternary organoammonium compound, such as tributylbenzyl ammonium chloride, polyallylamine, and the like.

With regards to the dimensional construction of some hose embodiments according to the disclosure, the overall hose thickness can be from about 3.0 mm to about 8.0 mm, or even from about 3.5 mm to about 5.0 mm. The layer thickness of the inner layer may be from about 0.1 mm to about 2.0 mm, or even from about 0.3 mm to about 1.2 mm. The layer thickness of the outer layer may be from about 0.8 mm to about 4.0 mm, or even from about 1.0 to about 2.0 mm. In those embodiments where an intermediate layer is incorporated, the layer thickness of the intermediate layer may be from about 0.5 mm to about 3.0 mm, or even from about 1.0 mm to about 2.0 mm.

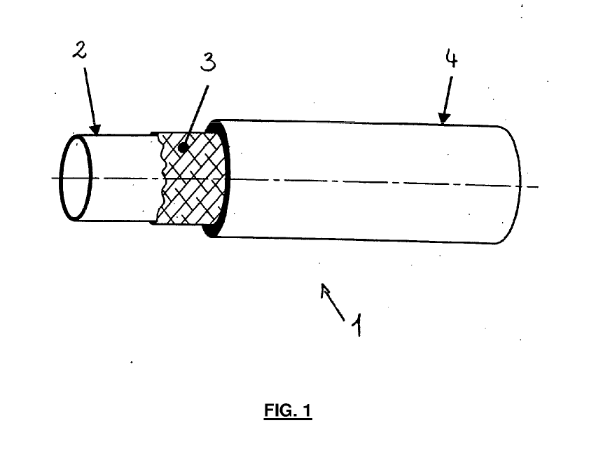

In the following, an embodiment of this disclosure is explained in more detail based on a drawing. The FIG. 1 is a three dimensional view of a charge-air hose. The hose 1 illustrated in FIG. 1 includes three layers arranged one on the other. In this respect the individual layers are each shown separately for better clarity—that is one section is exposed for each layer.

In detail the hose 1 comprises an inner layer 2, one or more textile reinforcing layers 3 and an outer layer 4. The inner layer 2 includes a fluoroelastomer and is provided with a textile reinforcing layer 3 lying directly on inner layer 2. In this respect the reinforcing layer 3 can partially or completely enclose the inner layer 2, e.g. if it is woven, but it can also be formed as open braiding, so that the outer layer 4 applied to the reinforcing layer 3 exhibits contact to the inner layer 2 through the open braiding. This type of open braiding, e.g. knitted textile, can therefore contribute to better adhesion of the individual layers. The outer layer here also includes EPM or EPDM elastomer.

While some embodiments above are described in the context of charge-air hoses, embodiments according to the disclosure are suitable anywhere good flexibility, engine media resistance, and/or acid/base resistance are needed, such as for industrial hoses, food and beverage hoses, chemical hoses, air conditioning hoses, oil hoses, and the like.

The foregoing description of the embodiments and examples has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A hose comprising:
an inner layer comprising a fluoroelastomer;
an outer layer comprising a EPDM elastomer, a EPM elastomer, or combination thereof;
at least one textile reinforcement layer; and,
an optional adhesion promoting layer;
wherein the at least one textile reinforcement layer is disposed between the inner layer and the outer layer, and wherein the optional adhesion promoting layer is disposed between two or more of the inner layer, the outer layer and the at least one textile reinforcement layer.

2. The hose according to claim 1, wherein the at least one textile reinforcement layer is wound directly onto inner layer.

3. The hose according to claim 1, wherein the at least one textile reinforcement layer is an open braid textile which facilitates direct contact between the outer layer and the inner layer.

4. The hose according to claim 1, wherein the fluoroelastomer has a fluorine content which is within the range of 64 weight percent to 71 weight percent.

5. The hose according to claim 4, wherein the fluoroelastomer has repeat units which are comprised of at least two perflurorinated monomers and at least one cure site monomer.

6. The hose according to claim 4, wherein the fluoroelastomer has repeat units which are comprised of a perfluoroolefin monomer, a perfluorovinyl ether monomer, and a cure site monomer.

7. The hose according to claim 6, wherein the perfluoroolefin monomer is selected from the group consisting of vinylidene fluoride, hexafluoropropylene, and tetrafluoroethylene.

8. The hose according to claim 6, wherein the perfluoroolefin monomer is present in the fluoroelastomer at a level which is within the range of 20 weight percent to 80 weight percent, wherein the perfluorovinyl ether monomer is present in the fluoroelastomer at a level which is within the range of 20 weight percent to 80 weight percent, and wherein the cure site monomer is present in the fluoroelastomer at a level which is within the range of 0.1 weight percent to 5 weight percent.

9. The hose according to claim 1, provided the outer layer is devoid of any silicone compound forming the outer layer.

10. The hose according to claim 1 further comprising an intermediate layer disposed between the inner layer and the outer layer, wherein the intermediate layer comprises fluoroelastomer, EPM elastomer, EPDM elastomer, or any combination thereof.

11. The hose according to claim 1, wherein the hose is a charge-air hose.

12. A charge-air hose comprising:
an inner layer comprising a fluoroelastomer;
an outer layer comprising a EPDM elastomer;
a textile reinforcement layer; and,
an adhesion promoting layer comprising an organophosphonium salt;
wherein the at least one textile reinforcement layer is disposed between the inner layer and the outer layer, and wherein the adhesion promoting layer is disposed between two or more of the inner layer, the outer layer and the textile reinforcement layer.

13. The charge-air hose according to claim 12, wherein the textile reinforcement layer is an open braid textile which facilitates direct contact between the outer layer and the inner layer.

14. The charge-air hose according to claim 12, wherein the fluoroelastomer has a fluorine content which is within the range of 64 weight percent to 71 weight percent.

15. The charge-air hose according to claim 14, wherein the fluoroelastomer has repeat units which are comprised of at least two perflurorinated monomers and at least one cure site monomer.

16. The charge-air hose according to claim 14, wherein the fluoroelastomer has repeat units which are comprised of a perfluoroolefin monomer, a perfluorovinyl ether monomer, and a cure site monomer.

17. The charge-air hose according to claim 16, wherein the perfluoroolefin monomer is selected from the group consisting of vinylidene fluoride, hexafluoropropylene, and tetrafluoroethylene.

18. The charge-air hose according to claim 16, wherein the perfluoroolefin monomer is present in the fluoroelastomer at a level which is within the range of 20 weight percent to 80 weight percent, wherein the perfluorovinyl ether monomer is present in the fluoroelastomer at a level which is within the range of 20 weight percent to 80 weight percent, and wherein the cure site monomer is present in the fluoroelastomer at a level which is within the range of 0.1 weight percent to 5 weight percent.

19. A hose comprising:
an inner layer comprising a fluoroelastomer;
an outer layer comprising a EPDM elastomer, a EPM elastomer, or
combination thereof; and,
at least one textile reinforcement layer;
wherein the at least one textile reinforcement layer is disposed between the inner layer and the outer layer, and provided the outer layer is devoid of any silicone compound forming the outer layer.

20. The hose according to claim 19 further comprising an adhesion promoting layer disposed between two or more of the inner layer, the outer layer and the at least one textile reinforcement layer.
